(19) United States
(12) Patent Application Publication
(10) Pub. No.: US 2016/0017897 A1
(43) Pub. Date: Jan. 21, 2016

(54) REGENERATIVE CIRCUIT OF HYDRAULIC APPARATUS

(71) Applicant: CATERPILLAR SARL, Geneva (CH)

(72) Inventors: Yuya KANENAWA, Tokyo (JP); Shuhei ORIMOTO, Tokyo (JP); Genta MINE, Tokyo (JP); Yudai ADOMI, Tokyo (JP)

(21) Appl. No.: 14/773,277

(22) PCT Filed: Feb. 27, 2014
(86) PCT No.: PCT/EP2014/025002

§ 371 Date: Sep. 4, 2015

(30) Foreign Application Priority Data
Mar. 6, 2013 (JP) 2013-044118

(51) Int. Cl. F15B 11/16; F15B 11/024; F15B 21/08

(52) U.S. Cl. CPC F15B 11/161; F15B 21/08; F15B 11/024; F15B 2211/205; F15B 2211/255

(57) ABSTRACT

An object of the present invention is to solve such problems associated with installing of a spool-type regenerative valve, in that an overall installation space of a hydraulic valve increases and processing that requires accuracy becomes complex. A regenerative circuit includes: a regenerative oil path provided in a valve body of a direction switching valve so as to connect a supply oil path connected to one side of a hydraulic actuator and a discharge oil path connected to the other side; and a regenerative valve which is a poppet-type flow regulating valve that is screwed into and attached to the valve body so as to control the flow of oil in the regenerative oil path according to an operation state of the direction switching valve.

### CROSS-REFERENCE TO RELATED APPLICATIONS

This application is a National Stage of International Patent Application No. PCT/EP2014/025002, filed Feb. 27, 2014, which claims priority to foreign Japanese Patent Application No. 2013-044118, filed Mar. 6, 2013, the content of which are incorporated herein by reference in their entirety.

### TECHNICAL FIELD

The present invention relates to a regenerative circuit that regenerates hydraulic oil discharged from a hydraulic actuator of a hydraulic apparatus and supplies the regenerated hydraulic oil to a supply side.

### BACKGROUND

For example, a construction machine like a hydraulic shovel includes a large number of hydraulic actuators, and a direction switching valve that supplies oil discharged from a pump to control operations is connected to each actuator.

A hydraulic circuit of a boom cylinder that raises and lowers a boom which is, for example, a working arm of a hydraulic shovel employs a regenerative circuit configured to supply oil discharged from the head side of a boom cylinder to the rod side to increase the amount of oil supplied to the rod side when oil discharged from a pump is supplied to the rod side of a boom cylinder according to the operation of a boom switching valve to contract the cylinder and lower the boom so that an operation speed can be increased and an energy saving operation can be realized (for example, see Patent Document 1).

An overview of the regenerative circuit will be described with reference to FIG. 2 (in which reference numerals are assigned to main components of FIG. 2 of Patent Document 1). A hydraulic circuit of a boom cylinder 50 includes a regenerative circuit 58 that supplies discharged oil passing through a head-side line 62 on the head side of the boom cylinder 50 to the rod side of the boom cylinder 50 when a spool 54 of a boom switching valve 52 is operated to supply oil discharged from a pump 56 to the rod side of the boom cylinder 50 through a rod-side line 60 to contract the boom cylinder 50 and lower the boom.

The regenerative circuit 58 is provided in the body of the boom switching valve 52 and includes a regenerative line 58a provided between the rod-side line 60 and the head-side line 62 and a regenerative valve spool 58b provided in the way of the regenerative line 58a.

When the spool 54 of the boom switching valve 52 is operated to a boom lowering position (boom cylinder contraction position), the hydraulic pilot oil causes the regenerative valve spool 58b in the regenerative line 58a to switch to a communication state. The oil discharged from the head side of the boom cylinder 50 is regenerated through the regenerative line 58a and supplied to the rod side.

A configuration in which the regenerative circuit 58 is attached directly to the boom cylinder 50 rather than being disposed in the body of the boom switching valve 52 (for example, see FIG. 1 of Patent Document 1).

Patent Document 1: Japanese Patent Application Publication No. H9-329106 (FIGS. 1 and 2)

### SUMMARY OF THE DISCLOSURE

The regenerative circuit of the conventional hydraulic apparatus having the above-described configuration has the following problems to be solved.

That is, a spool-type valve like the regenerative valve spool 58b is employed as the regenerative valve. Thus, when a plurality of spool-type direction switching valves is included as in a hydraulic shovel including a large number of hydraulic actuators in particular, spool-type regenerative valves are installed in addition to the direction switching valves. Thus, an overall installation space of the hydraulic valve increases and processing that requires accuracy for the spool valve becomes complex. Therefore, an improvement is needed from the perspective of space saving, ease of manufacturing, cost reduction, and the like.

With the foregoing in view, it is an object of the present invention to provide a regenerative circuit of a hydraulic apparatus capable of realizing space saving, ease of manufacturing, cost reduction, and the like by solving such problems associated with installing of spool-type regenerative valves, in that the overall installation space of the hydraulic valve increases, and the processing that requires accuracy becomes complex.

In order to solve the problems, according to an aspect of the present invention, there is provided a regenerative circuit of a hydraulic apparatus configured to, when a direction switching valve is operated to supply oil discharged from a pump to one side of a hydraulic actuator, divert oil discharged from the other side of the hydraulic actuator to supply the oil to the one side of the actuator, the regenerative circuit including: a regenerative oil path provided in a valve body of the direction switching valve so as to connect a supply oil path connected to the one side of the hydraulic actuator and a discharge oil path connected to the other side; and a regenerative valve which is a poppet-type flow regulating valve that is screwed into and attached to the valve body so as to control the flow of oil in the regenerative oil path according to an operation state of the direction switching valve, wherein the regenerative valve blocks the flow of oil from the discharge oil path to the supply oil path using a poppet, when an operation signal to supply oil to the one side is not supplied to the direction switching valve, and the regenerative valve allows the flow of oil from the discharge oil path to the supply oil path and controls a flow rate according to the operation signal when the operation signal to supply oil to the one side is supplied.

Preferably, the regenerative valve is an electromagnetic proportional flow regulating valve and increases or decreases the flow rate in proportion to the magnitude of the operation signal.

The regenerative circuit of the hydraulic apparatus configured according to the present invention includes the regenerative valve which is a poppet-type flow regulating valve that is screwed into and attached to the valve body so as to control the flow of oil in the regenerative oil path formed in the valve body of the direction switching valve according to an operation state of the direction switching valve.

Thus, since no spool is processed in the valve body of the direction switching valve unlike the conventional regenerative valve, the regenerative circuit can employ a commercial poppet-type flow regulating valve. Therefore, it is possible to solve such problems associated with the spool-type regenerative valve, in that the installation space of the hydraulic valve increases and the processing that requires accuracy becomes complex. As a result, it is possible to realize space saving, ease of manufacturing, cost reduction, and the like.

### BRIEF DESCRIPTION OF THE DRAWINGS

FIG. 1 is a regenerative circuit diagram of a hydraulic apparatus configured according to the present invention.

FIG. 2 is a regenerative circuit diagram of a conventional hydraulic apparatus.

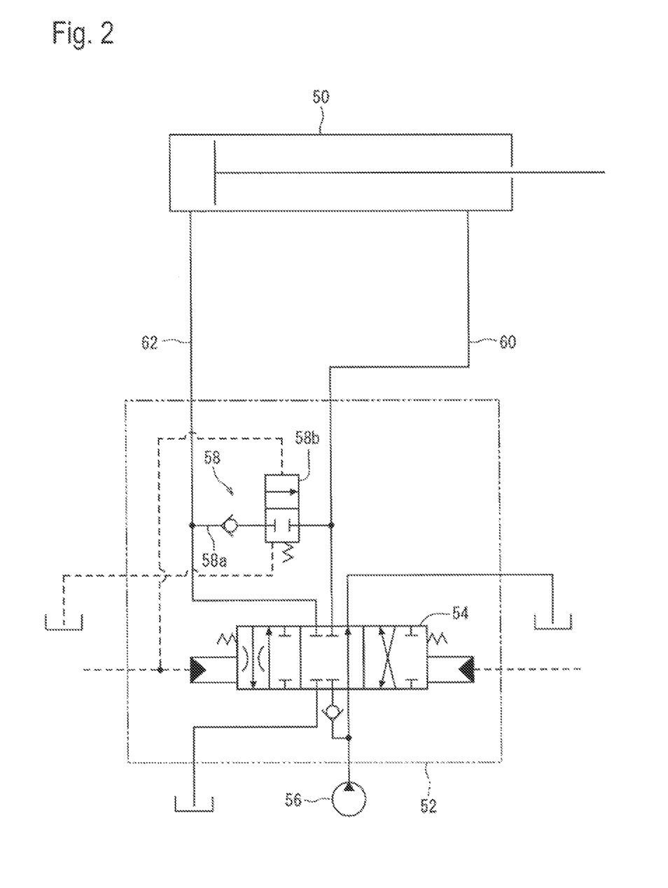

### BEST MODE FOR CARRYING OUT THE INVENTION

Hereinafter, a regenerative circuit of a hydraulic apparatus configured according to the present invention will be described with reference to the accompanying drawings illustrating a preferred embodiment.

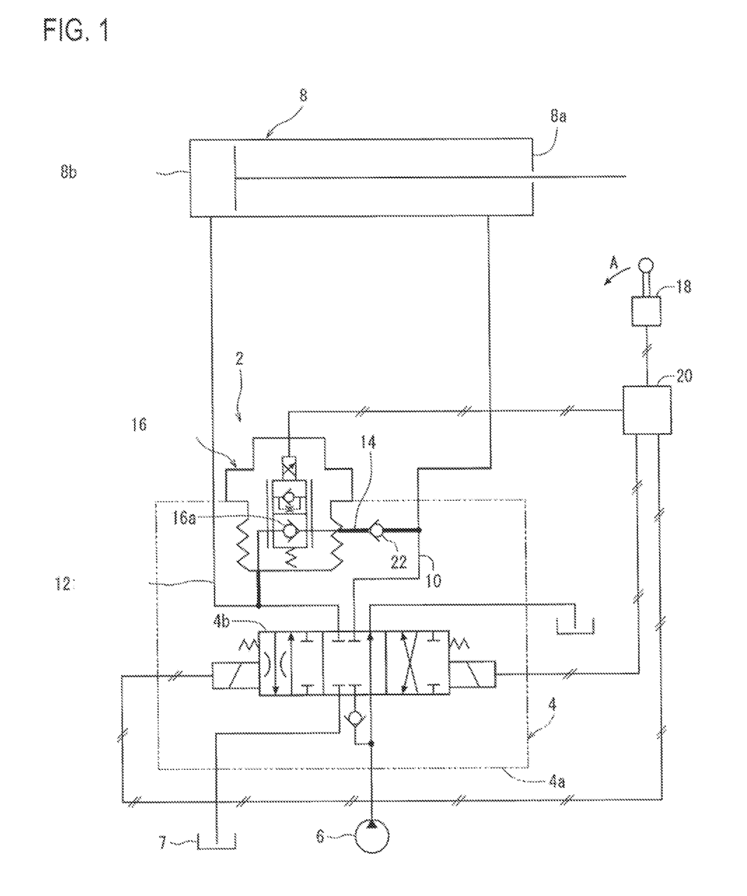

Referring to FIG. 1, the hydraulic apparatus includes a regenerative circuit 2 that, when a direction switching valve 4 is operated to supply oil discharged from a pump 6 to a rod side 8a which is one side of a cylinder 8 serving as an actuator, diverts oil discharged from a head side 8b which is the other side of the cylinder 8, and regenerates and supplies the discharged oil to the rod side 8a.

The hydraulic pump 6 and a tank 7 are connected to a supply port and a discharge port of a spool 4b of a valve body 4a of the direction switching valve 4. Two output ports of the spool 4b are connected to the rod side 8a and the head side 8b of the cylinder 8 through a supply oil path 10 and a discharge oil path 12.

The direction switching valve 4 is an electromagnetic switching valve having three positions of “Neutral,” “Cylinder Stretch,” and “Cylinder Contraction.” The position of the spool 4b of the direction switching valve 4 is changed from the “Neutral” position shown in the figure to the respective positions when an operator operates an operating lever 18 and an electrical signal is input from the operating lever 18 via a controller 20.

The regenerative circuit 2 includes a regenerative oil path 14 (depicted by bold lines) that is provided in the valve body 4a of the direction switching valve 4 so as to connect the supply oil path 10 and the discharge oil path 12 and a regenerative valve 16 that is attached to the valve body 4a so as to control the flow of oil in the regenerative oil path 14 according to an operation state of the spool 4b of the direction switching valve 4.

The regenerative valve 16 is a poppet-type flow regulating valve that is screwed into and attached to a female screw hole formed in the valve body 4a. The regenerative valve 16 is an electromagnetic proportional flow regulating valve and is configured to increase or decrease the flow rate in proportion to the magnitude of the operation signal described above. That is, the electrical signal of the operating lever 18, which is the operation signal, is input to the regenerative valve 16 via the controller 20.

When the operation signal to supply the hydraulic oil to the rod side 8a so that the direction switching valve 4 is switched to the “Cylinder Contraction” position is not supplied, the regenerative valve 16 blocks the flow of oil from the discharge oil path 12 to the supply oil path 10 using an internal poppet 16a. When the operation signal to supply the hydraulic oil to the head side 8b so that the direction switching valve 4 is switched to the “Cylinder Stretch” position is supplied, the regenerative valve 16 allows the flow of oil from the discharge oil path 12 to the supply oil path 10 and regulates the flow rate according to the operation signal.

As the poppet-type electromagnetic proportional flow regulating valve 16, commercial products sold by the name of “cartridge-type, poppet-type, and threaded-type electromagnetic proportional flow control valves” can be used. Thus, description of detailed structures thereof will not be provided.

The regenerative oil path 14 can be appropriately formed by hole drilling according to the shapes of the valve body 4a, the supply oil path 10, the discharge oil path 12, and the like so as to connect the supply oil path 10 and the discharge oil path 12. When the valve body 4a is formed of a cast metal, the regenerative oil path 14 may be formed as a cast hole.

In FIG. 1, a check valve 22 is provided between the regenerative valve 16 of the regenerative oil path 14 and the supply oil path 10 so as to allow the flow of oil from the regenerative valve 16 to the supply oil path 10 and prevent the flow of oil from the supply oil path 10 to the regenerative valve 16. The check valve 22 may not be provided when it is used for such purposes where the cylinder 8 raises and lowers a load such that when the cylinder 8 is contracted, the pressure of the rod side 8a is lower than the head side 8b so that the regenerative oil is sucked and supplied to the rod side 8a.

The regenerative operation of the regenerative circuit 2 will be described. When the cylinder 8 is contracted (that is, the operating lever 18 is operated from the neutral position (the illustrated position) toward the contracted position (indicated by “A”), the operation signal to supply the hydraulic oil to the rod side 8a corresponding to the operation is input to the spool 4b of the direction switching valve 4 and respective electromagnetic means of the regenerative valve 16 via the controller 20. As a result, the spool 4b is moved in the direction for the “Cylinder Contraction” position. The oil discharged from the pump 6 to the spool 4b is supplied to the rod side 8a of the cylinder 8 through the supply oil path 10. The oil discharged from the head side 8b of the cylinder 8 is discharged to the tank 13 through the spool 4b along the discharge oil path 12. A portion of the discharge oil is regenerated through the regenerative oil path 14 and supplied to the supply oil path 10 with the flow rate regulated in proportion to the magnitude of the operation signal of the regenerative valve 16.

The advantageous effects of the regenerative circuit 2 of the hydraulic apparatus will be described.

The regenerative circuit 2 of the hydraulic apparatus configured according to the present invention includes the regenerative valve 16 which is a poppet-type flow regulating valve that is screwed into and attached to the valve body 4a so as to control the flow of oil in the regenerative circuit 2 formed in the valve body 4a of the direction switching valve 4 according to an operation state of the direction switching valve 4. Thus, since no spool is processed in the valve body of the direction switching valve unlike the conventional regenerative valve, the space for the spool can be saved and the regenerative circuit can employ a commercial poppet-type flow regulating valve. Therefore, it is possible to solve such problems associated with the spool-type regenerative valve, in that the installation space of the hydraulic valve increases and the processing that requires accuracy becomes complex. As a result, it is possible to realize space saving, ease of manufacturing, cost reduction, and the like.

Moreover, since the regenerative valve 16 is an electromagnetic proportional flow regulating valve and increases or decreases the flow rate in proportion to the magnitude of the operation signal, it is possible to more finely set the operation speed of the actuator 8 and to broaden the width of control.

While the present invention has been described in detail based on the embodiment, the present invention is not limited to the embodiment, but various alterations or modifications as below can be made within the scope of the present invention.

In the embodiment of the present invention, the regenerative circuit 2 is configured to, when the direction switching valve 4 is operated to supply the oil discharged from the pump 6 to the rod side 8a on one side of the cylinder 8 serving as an actuator, divert the oil discharged from the head side 8b on the other side of the cylinder 8 to supply the oil to the rod side 8a of the cylinder 8. However, depending on the operation mode of the actuator 8, the regenerative circuit 2 may be configured to divert the oil discharged from the rod side 8a on one side of the cylinder 8 to supply the oil to the head side 8b of the cylinder 8.

In the embodiment of the present invention, although the direction switching valve 4 is an electromagnetic switching valve, the direction switching valve may be a hydraulic pilot-type switching valve or a manual switching valve.

Moreover, in the embodiment of the present invention, the regenerative valve 16 is an electromagnetic proportional flow regulating valve, the regenerative valve may not be an electromagnetic flow regulating valve but may be a flow regulating valve capable of regulating the flow rate to a predetermined value.

### EXPLANATION OF REFERENCE NUMERALS

2: Regenerative circuit

4: Direction switching valve

4a: Valve body

8: Cylinder (Actuator)

8a: Rod side (One side)

8b: Head side (The other side)

10: Supply oil path

12: Discharge oil path

14: Regenerative oil path

16: Regenerative valve

1. A regenerative circuit of a hydraulic apparatus configured to, when a direction switching valve is operated to supply oil discharged from a pump to one side of a hydraulic actuator, divert oil discharged from the other side of the hydraulic actuator to supply the oil to the one side of the actuator, the regenerative circuit comprising:
a regenerative oil path provided in a valve body of the direction switching valve so as to connect a supply oil path connected to one side of the hydraulic actuator and a discharge oil path connected to the other side; and
a regenerative valve which is a poppet-type flow regulating valve that is screwed into and attached to the valve body so as to control the flow of oil in the regenerative oil path according to an operation state of the direction switching valve, wherein
the regenerative valve blocks the flow of oil from the discharge oil path to the supply oil path using a poppet, when an operation signal to supply oil to the one side is not supplied to the direction switching valve, and
the regenerative valve allows the flow of oil from the discharge oil path to the supply oil path and controls a flow rate according to the operation signal when the operation signal to supply oil to the one side is supplied.

2. The regenerative circuit of a hydraulic apparatus according to claim 1, wherein
the regenerative valve is an electromagnetic proportional flow regulating valve and increases or decreases the flow rate in proportion to the magnitude of the operation signal.
